(19) United States
(12) Patent Application Publication
(10) Pub. No.: US 2002/0029574 A1
(43) Pub. Date: Mar. 14, 2002

(54) Apparatus for dissolving, liquefying and introducing CO2 gas into the deep sea for storage there

(76) Inventor: Takeshi Yoshioka, Yachiyo City (JP)

Correspondence Address: LEONARD BLOOM & ASSOCIATES, LLC, Intellectual Property Law Offices, Suite 905, 401 Washington Avenue, Towson, MD, 21204, US

(21) Appl. No.: 09/739,573

(22) Filed: Dec. 18, 2000

(30) Foreign Application Priority Data
Sep. 13, 2000 (JP) 318562/2000

(51) Int. Cl. F17C 1/00; A62D 3/00

(52) U.S. Cl. 62/53.1; 588/250

(57) ABSTRACT

A low cost teqhnique is disclosed for dissolving, liquefying and introducing CO₂ gas into the deep sea for storage there, which involves low pressure and is simple in structure, easy to operate and maintain, safe, and relatively free of breakdown. The apparatus comprises a pipe for transporting a mixture of the CO₂ gas and the seawater or other liquid, extending from above the sea or from the ground into the deep sea, a pump for moving the gas and a pump for moving the liquid, or a single pump for moving both the gas and the liquid, whereby the gas-liquid mixture is formed and introduced into the deep see through the same pipe, the CO₂ gas in the mixture being pressurized, agitated, dissolved and liquefied during its transport through the pipe with the result that its bubbles are eliminated and buoyancy decreased, thereby making it possible to release the CO₂ into the deep sea with a relatively small pumping force.

### FIELD OF THE INVENTION

CO₂ gas is said to be the cause of global warming. This invention relates to a technology for dissolving, liquefying and introducing Such CO₂ gas into the deep sea or other deep water such as the one at the site of oil excavation for deposit and storage there.

### BACKGROUND OF THE INVENTION

In view of the ever-increasing necessity for storing CO₂ gas in the deep sea, various methods have been proposed to achieve the purpose. However, none of such conventional methods are satisfactory for practical purposes because they require a complicated equipment or process for generating high pressure, liquefaction, refrigeration, etc., adding to the cost. Some of such proposed conventional methods are as follows:

(1) Introduce CO₂ in a gaseous form into the Sea about 400 m deep.

(2) Introduce the gas and the sea water into a semi-open, air-tight container to obtain the sea-water saturated with CO₂.

(3) Blow the gas into an inverted-U tube to dissolve the gas in the seawater by its gas-lifting action and introduce such water-dissolved gas into the seawater at the depth of more than 1,000 m.

(4) Blow the liquefied CO₂ gas into the seawater about 700 m to 1,000 m deep (its sedimentation as a CO₂ hydrate is also expected).

(5) Inject the liquefied CO₂ directly into the deep sea at the depth of more than 3,700 m.

(6) Liquefy CO₂ by cooling it to the temperature of 45° C. below zero and release such liquefied gas in a globular form of about 1 m in diameter into the seawater through a pipe extending into the seawater about 500 m deep. Since the specific gravity of the liquefied CO₂ is greater than that of the seawater, the CO₂ sinks into the deep sea. It is said that the liquefied CO₂ can be stored in a stable condition if it is sunk to the depth of more than 3,500 m.

(7) Introduce the liquefied CO₂ to a crystalizer installed at the sea depth where a hydrate of CO₂ can be formed and cause it to react with the seawater to form CO₂ hydrate particles which have a greater density than the seawater. Then the particles are allowed to go down in the seawater and deposit on the seabed.

All of the aforementioned conventional methods require high-pressurization on the order of tens of atms, refrigeration, liquefaction, or extension of the piping to an ultra sea depth (more than 1,000 m) and are unsatisfactory for the processing of a huge volume of CO₂ gas to be generated in the future in that they require unduly large and complicated equipment and processes which are not easy to handle and present safety and cost problems, thereby causing difficulty in their practical application. A deep-sea storage technique has been sought wherein a low-pressure pump (several atms) can be used, refrigeration is not required, a simple equipment (only a pump) is sufficient, a small number of steps is involved, and a easy handling, increased safety and lower cost can be ensured.

### SUMMARY OF THE INVENTION

It is therefore a primary object of the present invention to provide a technique for the storage of CO₂ gas in the deep sea which, unlike complicated conventional techniques as referred to above, utilizes the simple principles of the nature, involves simple equipment and a smaller number of steps, requires no substantial refrigeration or pressurization exceeding 10 atms, and is easy to maintain and less expensive.

According to the present invention, the advantages of changes in the condition of a gas-liquid multiphase flow (hereinafter referred to as a “gas-liquid mixture”)that occur in the water are utilized to eliminate the aforementioned numerous problems with the conventional methods, by providing an apparatus comprising a pipe 1 extending from above the sea or from the ground into the deep water, a pump 2 provided above the water or on the ground and adapted to forcibly move CO₂ gas, a pump 3 adapted to forcibly move the seawater or other liquid, the pump 2 and the pump 3 being simataneously operable to move CO₂ gas and the seawater or other liquid through the common pipe 1 thereby forming a gas-liquid mixture and introducing such mixture into the deep sea, the bubbles of the CO₂ gas being decreased in size due to increased water pressure as the sea depth increases and consequently the buoylancy of the CO₂ gas being decreased, such that the gas is further dissolved and liquefied in the seawater or other liquid and its bubbles eliminated and is eventually discharged through an exit 4 into the deep sea so as to be allowed to floatingly descend in the seawater to the seabed.

Another object of the present invention is to provide an apparatus comprising a pipe 1 extending from above the water or from the ground into the deep water, a pump 5 provided above the sea or on the ground and adapted to transport both the CO₂ gas and the seawater or other liquid in the form of a gas-liquid mixture into the deep water, thereby reducing the size of the bubbles of the CO₂ and consequently its buoyancy, further dissolving and liquefying the CO₂ gas in the seawater or other liquid, removing the bubbles of the CO₂ as it is thus transported and eventually discharing the CO₂ gas from the exit 4 into the deep sea against the high pressure of the surrounding deep-sea water in a condition where the density of the seawater in the mixture is increased, allowing the mixture to floatingly descend in the deep sea onto its seabed.

Still another object of the present invention is to provide an apparatus comprising the pumps 2 and 3 or the pump 5 installed inside a closed chamber 6 in which the CO₂ gas and the sea water or other liquid are stored.

### DETAILED DESCRIPTION OF THE PREFERRED EMBODIMENTS

An embodiment of the apparatus for dissolving, liquefying and introducing CO₂ gas into the deep sea for storage there as claimed by claim 1 is described in reference to FIG. 1. A pipe 1 is extended into the deep water from above the sea or from the ground. Above the sea or on the ground are provided a pump 1 for transporting CO₂ gas and a pump 3 for transporting the seawater or other liquid. The pump 2 and the pump 3 are simultaneously operated to mix the CO₂ gas with the seawater or other liquid inside the, common pipe 1 and introduce such mixture into the deep sea through the pipe. Since water pressure increases with the increase in the sea depth as the mixture is transported, the bubbles of the CO₂ gas are reduced and consequently its buoyancy is reduced, and the dissolution and liquefaction of the CO₂ gas in the seawater or other liquid in the mixture are accelerated. As the mixture gas is further transported, the bubbles of the CO₂ gas are completely eliminated, and the gas is finally discharged from exit 4 into the deep against the pressure of the ambient deep sea water in a condition where the density of the seawater or other liquid in the mixture is highly increased and is allowed to floatingly descend in the deep sea for deposit on the seabed.

Another embodiment of the present invention as claimed by claim 2 comprises a pipe 1 extending into the deep sea from above the sea or from ground and a pump 5 for transporting the mixture of CO₂ gas and the seawater or other liquid. Due to an increase in the water pressure resulting from an increase in the sea depth as the mixture is transported by the pump 5 through the pipe 1, the bubbles of the CO₂ gas are reduced and conssequently its buoyancy decreased, the dissolution and liquefaction of CO₂ in the seawater or other liquid in the mixture further propgress and the bubbles of the CO₂ gas eventually become nonexistent. The CO₂ is finally discharged into the deep sea through the exit 4 against the pressure of the surrounding deep-sea water in a condition where the density of the seawater or other liquid in the mixture is highly increased. The gas is then allowed to floatingly descend in the deep sea onto its seabed.

Still another embodiment of the present invention as claimed by claim 3 is to install the pumps 2 and 3 or the pump 5 inside a closed storage chamber 6 in which both the CO₂ gas and the seawater or other liquid are stored under high pressure as a mixture in an almost saturated condition.

The apparatus claimed by claim 1 uses the pump 2 for the CO₂ gas and the pump 3 for the seawater or other liquid, both pumps being simultaneously operable to generate the flow of the gas-liquid mixture. In the apparatus of claim 2, a single pump 5 can generate such flow of the gas-liquid mixture.

Following are the reasons for utilizing gas-liquid mixtures to dissolve and liquefy CO₂ gas for storage in the deep sea as claimed in claims 1, 2, and 3:

(1) It is possible to decrease the average buoyancy of CO₂ under the water to less than one-half of the buoyancy of CO₂ in the gaseous state by adjusting the volume ratio between the gas and the liquid before they are transported from above the water or from the ground. In other words, CO₂ in such mixture state can be brought into the water more than two times deeper than in the case where it is tansported in a gaseous state. However, the total volume of the gas is reduced as the ratio of the gas to the liquid in the mixture is reduced.

(2) As the gas-liquid mixture is introduced into the water, the volume of the gas is reduced by the increase in water pressure as the water depth increases. For example, at the water depth of 10 m, the volume of the gas in the gas-liquid mixture is reduced by one-half and at the depth of 20 m its volume is reduced to one-third, resulting in its reduced buoyancy and consequenty in a reduced force required to transport it. At the water depth of Dm, the volume V(m) of the gas is expressed by the following formula:

V=10V₁/(D+10), where V₁ (mg) is the volume of the gas above the water or on the ground. Changes in the water depth and the volume of the gas are shown in FIG. 6.

Thus, since the volume of the gas is reduced by the increased water pressure as the water depth increases, the buoyancy of the gas under the water is further reduced, thereby making it possible to introduce the gas still deeper into the water assisted by said advantages of the gas-liquid mixture, with the water pressure increasing as the water depth increases.

For example, with the force of 5 kgf/cm², CO₂ gas alone can only be brought to the depth of about 50 m under the water because its buoyancy is 100%. On the other hand, the same volume of CO₂ in a gas-liquid mixture with the gas-liquid ratio of 50% can be brought to the depth of about 100m with the force of 5 kgf/cm² because the average buoyancy is reduced by 50%. The volume of the gas is further reduced as the water depth increases and at the water depth of 100 m, its volume is reduced to about one-half of its original volume, thereby making it possible to introduce the gas still deeper into the water beyond said 100 m depth.

(2) Second, even in a saturated gas-liquid mixture, the CO₂ gas is further dissolved and liquefied in the water since the water pressure increases as the water depth increases. When the water pressure has more than doubled as the water depth increases, approximately the same volume of CO₂ gas as that of the seawater is dissolved and liquefied in the seawater in the gas-water mixture. In other words, the solubility of the CO₂ gas into the water is 0.88 to 1.71 (at 20° C. to 0° C.) . When the CO₂ gas is trasnported in a saturated gas-liquid mixture at the water temperature of 15° C. and is agitated at the water depth where the water pressure has doubled, almost all of the CO₂ gas is dissolved and liquefied and its gas bubbles eliminated as shown in FIG. 1, FIG. 2 and FIG. 5, and at the depth greater than that, it buoyancy is lost because of complete removal of the gas bubbles.

For example, when a saturated CO₂-seawater mixture in equal parts above the sea level is brought to the sea depth of 10 kgf/cm² (100 m depth) and agitated, almost all of the CO₂ gas is dissolved and liquefied in the seawater. At a depth greater than 100 m, the gas bubbles of the CO₂ gas become nonexistent and its buoyancy is lost. Thus, the mixture can be brought to the water depth of greater than 500 m from above the sea even under the pressure of 5 kgf/cm². As the result of an increase in the density of the seawater caused by the dissolution and liquefaction of the CO₂, a descending force is generated, although slightly, thereby reducing the force required to introduce the mixture into the water.

The degree of the reduction of the volume of the gas bubbles due to its dissolution and liquifaction is greater than the degree of the reduction of the volume of the gas due to the increased depth to which it is brought as described in (2). At the temperature of about 15° C., the bubbles of the CO₂ gas disappear when the water pressure is doubled. At a greater depth, its buoyancy is lost.

In actual operation, the principles described in (1), (2) and (3) above co-work simultaneously and synergistically with the result that the gas bubbles of the gas-liquid mixture are rapidly reduced and eventually eliminated and the buoyancy of the CO₂ gas is sharply reduced, thereby making it possible to introduce the mixture into the deep sea with a relatively small pumping force.

Thus, according to these principles, CO₂ gas saturated with the same volume of the seawater above the sea can be brought to the depth of 500 m or more even with the force of about 5 kgf/cm². In other words, CO₂ in a gas-liquid mixture can be brought to the water depth more than ten times greater than in the case where it is transported in a gaseous state.

In claims 1, 2 and 3, gas-liquid mixtures are described as having equal parts of the gas and the liquids. However, the volume ratio of the saturated CO₂ to the seawater may be varied. Also, the pumping force may be greater than 5 kgf/cm². The flow velocity of the gas-liquid miture in the pipe 1 may be increased. An increase in the pumping force increases the flow low velocity, thereby making it possible to extend the pipe deeper into the water and increase the diameter of the pipe In this case, there are additional advantages that the descending force of the mixture is increased due to the increased density of the seawater resulting from the dissolution and liquefaction of the CO₂ gas such that a less pumping force may be required. When the flow velocity is increased at a high pumping force, the flow resistance increases in proportion to the square of the flow velocity, adding to the cost of pumping. Therefore, it is recommended that the economical factor is taken into consideration when determining the pumping force.

In claims 1, 2, and 3, the volume ratio between the gas and the liquid in the gas-liquid mixture need not be the same. Either component may be greater than the other. If the percentage of the gas is greater than that of the liquid, a higher pressure and consequently a greater water depth are required for the dissolution and liquefaction of the gas in the liquid. Naturally, the opposite could occur.

In claims 1, 2, and 3, the gas-liquid mixture can be most effectively introduced into the sea in a direction perpendicular to the seabed. However, such direction may be somewhat slanted or not straight. The speed of the injection must be greater than the floating speed of the gas bubbles. For this purpose, the diameter of the pipe may be varied at appropriate places.

In claims 1, 2, and 3, the injection of the gas-liquid mixture always encounters the floating of the bubbles. Therefore, the injection speed of the gas-liquid mixture into the sea must be greater than the floating speed of the bubbles. The flow speed of 1.5 m/sec is normally most desirable. If the speed is 0.5 m/sec or less, the mixture may not be formed or the gas (bubbles) may not be compressed.

In claims 1, 2, and 3, the diameter of the pipe may be changed to adjust the flow speed of the gas-liquid mixture to the optimal range of 1 to 2.5 m/sec.

In claims 2 and 3, the pump 5 for injection of the gas-liquid mixture into the Sea is a single pumping apparatus capable of transporting gas-liquid mixtures such as those disclosed in Japanese Laid-Open Patent Applications Nos. 201071/1999 (“An Apparatus for Transporting Gas-Liquid Mixtures”) , 336687/1999 (“A Pump for Gas-Liquid Mixtures”), and 170649/2000 (“An Involute Pump for Gas-Liquid Mixtures”) . Such pumps can easily inject CO₂ gas into the deep sea.

It one of the said pumps is used for transporting gas-liquid mixtures in claim 2, a single unit of the pump is sufficient when the required pumping force is relatively small. However, as shown in FIG. 2, multiple units of the pump connected in a series may be used to apply a higher pressure on the gas-liquid mixtures. In this case, it is desirable to adjust the volume ratio between the gas and the liquid to an appropriate range, and on the second and subsequent units of the pump, a liquid volume regulator 11 may be provided.

As described above in detail, the present invention will provide the following novel features and advantages:

(1) The gas-liquid mixture can reach the sea depth more than two times greater than the gas alone.

(2) In the gas-liquid mixture, the dissolution and liquefaction of the CO₂ gas are accelerated because pressurization and agitation occur during the transport of the mixture.

(3) The deeper the gas-liquid mixture is brought, the more pressure is applied thereon, resulting in the reduction of the volume of its bubbles and of its buoyancy, thereby decreasing the force required to transport the gas.

(4) The increased pressure resulting from the increased sea depth accelerates the dissolution and liquefaction of CO₂ gas in the seawater and the elimination of its bubbles with the result that its overall buoyancy is decreased and consequently a less force is required to transport it.

(5) The higher pressure resulting from the increased sea depth, the reduction of the gas bubbles and the acceleration of its dissolution and liquifaction work synergetically to completely eliminate the bubbles of CO₂ gas, thereby making it possible to bring the mixture to a sea depth more than ten times greater than in the case of the gas alone with the same pumping force.

(6) No special process of pressurization, refrigeration and liquifacion are required. Only a simple mechanical operation is sufficient.

(7) Since no high pressure object or refrigerated object is involved, the operation can be made easy and safe.

(8) Since the cooling, compression and pressurization of the gas are conducted while it is transported in the water in the gas-water mixture, the need for high pressure or cooling equipment can be eliminated, thereby achieving the economy of the equipment.

(9) Even a single unit of those gas-liquid pumps recently developed can be used without causing any substantial noise or vibration.

(10) The total process and equipment can be made simple, thereby decreasing the cost of equipment, operation and safety.

(11) At the water depth of not more than 200 m, all bubbles can be eliminated and all gas can be dissolved and liquefied in the sea water of the gas-liquid mixture. Thus, the gas-liquid mixture can be discharged into the sea at the depth of about 500 m and the piping longer than 1,000 m is not required in other than exceptional circumstances.

All of the aforementioned features and advantages can be provided by the gas-liquid mixture of the present invention and not by any of the conventional techniques as above described.

### BRIEF DESCRIPTION OF THE DRAWINGS

The accompanying drawings only show the of this invention and are not limited to the embodiments shown thereby. Many more embodiments are possible on the basis of such drawings. In FIGS. 2 and 5, the cross-sectional view of the pump 5 is not shown but is substantially the same as the cross-sectional view of the pump 5 shown in FIG. 4.

FIG. 1 shows the apparatus according to the present invention as claimed in claim 1 end shows the pump 2 for compressing CO₂ gas and the pump 3 for transporting the seawater or other liquid, the two pumps cooperating to form the gas-liquid mixture of the present invention.

FIG. 2 shows the apparatus according to the present invention as claimed in claim 2 or 3 and shows the use of multiple units of the pump 5 (5-1 and 5-2) for transporting the CO₂ gas and the seawater or other liquid as a gas-liquid mixture.

FIG. 3 shows the apparatus according to the present invention as claimed in claim 2 or 3, in which the pump 5 for transporting gas-liquid mixtures is provided within the pressurized gas.

FIG. 4 shows the cross-sections of the pump 5 in FIG. 3 at A, B, and C, respectively.

FIG. 5 shows the apparatus according to the present invention as claimed in claim 2 or 3, in which the pump 5 for transporting the CO₂ gas and the seawater or other liquid as gas-liquid mixtures is provided inside the storage chamber.

FIG. 6 is a graph illustrating changes in the water depth, water pressure and volume of the bubbles in connection with claims 1, 2, and 3.

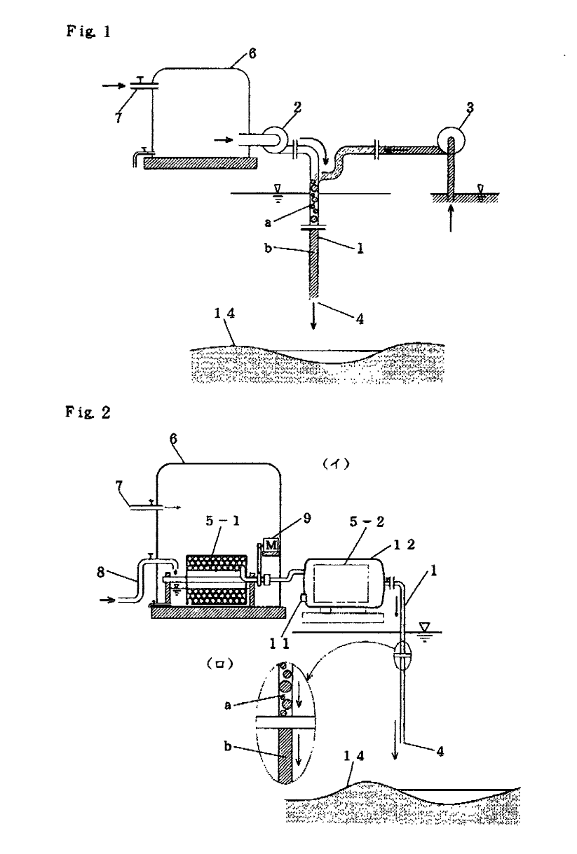

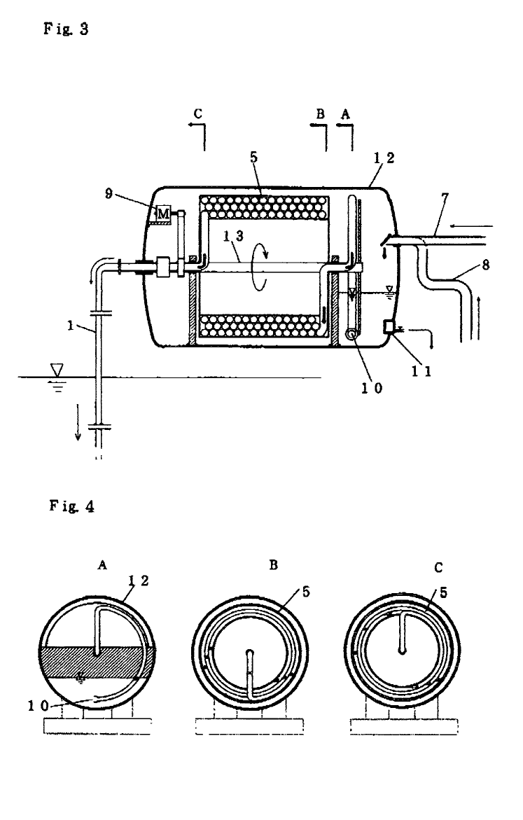

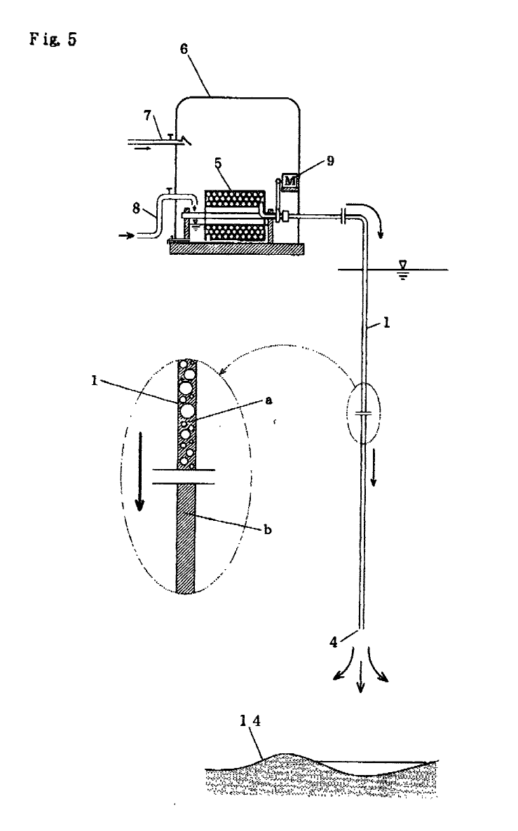

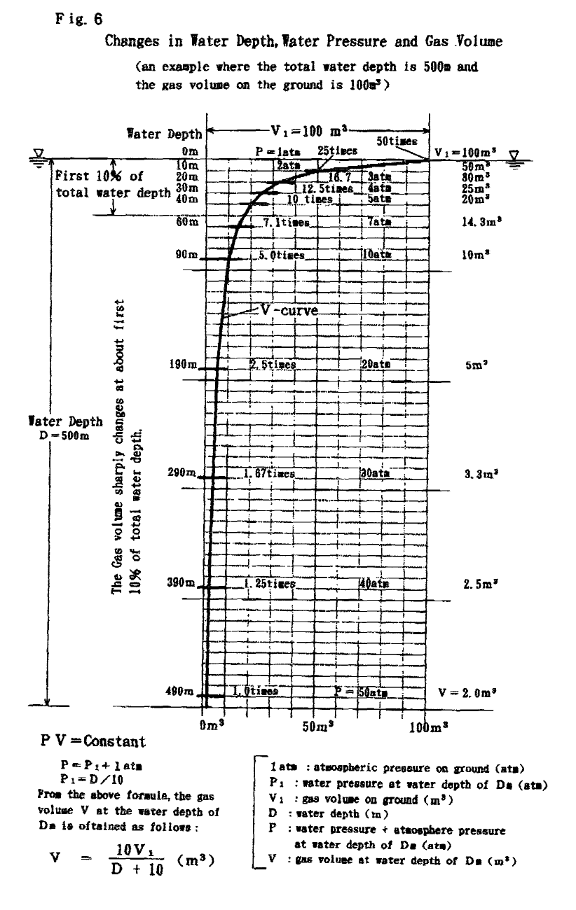

In the drawings;

1 . . . pipe, 2 . . . pump, 3 . . . pump, 4 . . . exit, 5 . . . pump, 6 . . . storage chamber, 7 . . . inlet for CO₂ gas, 8 . . . inlet for the seawater or other liquid, 9 . . . motor or engine, 10 . . . inlet for the gas-liquid mixture, 11 . . . liquid volume regulator, 12 . . . closed storage chamber, 13 . . . rotary shaft, 14 . . . seabed, a . . . area where bubbles are reduced, b . . . area where bubbles are eliminated.

What is claimed is:

1. An apparatus for dissolving, liquefying and introducing CO₂ gas into the deep sea for storage there, comprising a pipe 1 extending from above the sea or from the ground into the deep sea, a pump 2 provided above the sea or on the ground for transporting CO₂ gas and a pump 3 for transporting the seawater or other liquid, thereby forming a mixture of the CO₂ gas and the seawater or other liquid in the pipe 1 and discharging the mixture under high pressure from an exit 4 into the deep sea with the density of the seawater or other liquid in the mixture highly increased, allowing the mixture to floatingly descend to the bottom of the sea, the bubbles of the CO₂ gas being reduced and eventually eliminated to reduce its buoyancy and the dissolution and liquefaction of the CO₂ gas in the seawater being accelerated during its transport through the pipe due to the increase in water pressure as the water depth increases.

2. An apparatus for dissolving, liquefying and introducing CO₂ gas into the deep sea for storage there, comprising a pipe 1 extending from above the Sea or from the ground into the deep sea and a pump 5 adapted for transporting both the CO₂ gas and the seawater or other liquid as a gas-liquid mixture through the pipe, thereby bringing the mixture into the deep sea and discharging it under high pressure from an exit 4 into the deep sea with the density of the seawater or other liquid in the mixture highly increased, allowing the mixture to floatingly descend to the bottom of the sea, the bubbles of the CO₂ gas being reduced and eventually eliminated and its buoyancy decreased and the dissolution and liquifaction of the CO₂ gas in the seawater or other liquid being accelerated during its transport through the pipe due to the increase in water pressure as the water depth increases.

3. The apparatus as claimed in claim 1 or 2, wherein the pumps 2 and 3 or the pump 5 is installed inside a storage chamber 6 filled with the mixture of the CO₂ and the seawater or other liquid.
